(19) United States
(12) Patent Application Publication
(10) Pub. No.: US 2013/0157111 A1
(43) Pub. Date: Jun. 20, 2013

(54) BIPOLAR ELECTROCHEMICAL BATTERY WITH AN IMPROVED CASING

(71) Applicants: Marianne Chami, Fontaine (FR); Lionel Picard, Seyssinet (FR)

(72) Inventors: Marianne Chami, Fontaine (FR); Lionel Picard, Seyssinet (FR)

(73) Assignee: COMMISSARIAT A L'ENRGIE ATOMIQUE ET AUX ENE ALT, Paris (FR)

(21) Appl. No.: 13/818,191

(22) PCT Filed: Aug. 23, 2011
(86) PCT No.: PCT/EP11/64417

§ 371 Date: Feb. 21, 2013

(30) Foreign Application Priority Data
Aug. 24, 2010 (FR) 10 56731

(51) Int. Cl. H01M 2/02

(52) U.S. Cl. CPC H01M 2/029
USPC 429/157; 429/163; 156/307.1; 156/307.3

(57) ABSTRACT

A casing for a lithium bipolar electrochemical battery including a bipolar element. The casing includes a composite material including a matrix and at least one porous reinforcement, the matrix of which includes at least one hardened polymer impregnating the at least one porous reinforcement, wherein the at least one porous reinforcement and the at least one hardened polymer encase the bipolar element and maintain a determined pressure on either side of the bipolar element to maintain a determined contact between its constituents.

### TECHNICAL FIELD

The present invention relates to the field of lithium electrochemical generators, which operate according to the principle of insertion or deinsertion, or in other words intercalation-deintercalation, of lithium in at least one electrode.

It relates more specifically to a lithium electrochemical battery including at least one current collector with a bipolar function, also called a bipolar battery: in such a bipolar battery the bipolar collector, also called the bipolar electrode, supports on each of its opposite faces one of the electrode materials with the opposite sign, i.e. with a cathode (positive electrode) supported by one of the faces and an anode (negative electrode) supported by the other of the opposite faces.

The aim of the invention is to produce a novel electrochemical battery casing, and more specifically a casing of a bipolar battery, and also to replace known casings of the flexible or rigid type.

### PRIOR ART

The architecture of conventional lithium-ion batteries is an architecture which may be qualified as monopolar, since it has a single electrochemical cell including one anode, one cathode and an electrolyte. Several types of monopolar architecture geometry are known:
a cylindrical geometry such as the one disclosed in patent application US 2006/0121348,
a prismatic geometry such as the one disclosed in patents U.S. Pat. No. 7,348,098, U.S. Pat. No. 7,338,733;
a stack-based geometry such as the one disclosed in patent applications US 2008/060189, US 2008/0057392, and U.S. Pat. No. 7,335,448.

A monopolar architecture is achieved by winding. The winding consists of a current collector on which a positive electrode (cathode) material is continuously deposited, a separator made of polymer or ceramic material which is sandwiched within a negative electrode (anode) material, which is itself deposited on another current collector. The main advantage of this monopolar architecture is that it has a large active area of material, but the potential difference is limited to the unit value of the potential difference between the two electrode materials used, which is also the case with a stack-based geometry.

To increase the average potential of a monopolar Li-ion battery, whilst retaining a comparable energy density, it is known to produce a battery with multiple electrochemical cells in series. The architecture of the battery is thus qualified as bipolar, since it includes a cathode of one cell and an anode of an adjacent cell, which are supported by the same current collector in the form of a plate, which is itself qualified as a bipolar electrode. The architecture of a bipolar battery is thus a connection in series of several monopolar batteries through bipolar electrodes or current collectors with, however, the advantage that it has a lower electrical resistance compared to monopolar batteries connected in series by external connectors. Many patent applications or patents concerning such bipolar batteries may be cited in this connection, such as U.S. Pat. No. 7,279,248, U.S. Pat. No. 7,220,516, U.S. Pat. No. 7,320,846, U.S. Pat. No. 7,163,765, WO 03/047021, WO 2006/061696, U.S. Pat. No. 7,097,937 and US 2007/00115047.

The subsequent advantages of bipolar batterys are that they have lower mass, a lower electrical resistance, and that they do not include superfluous volumes.

The main difficulty in designing a bipolar battery is the production of compartments which are perfectly sealed against the electrolyte, in general in liquid form, from one another. Indeed, poor sealing causes bipolar batteries to malfunction.

This is, moreover, corroborated by the fact that most of the patent literature relating to the field of bipolar Li-ion batteries relates to sealing solutions to prevent leakages of electrolyte from one compartment to another (ion short circuits).

Among the patent applications or patents as mentioned above, patent U.S. Pat. No. 7,220,516 may be mentioned, which describes a solution with a seal between compartments, and with a flexible adhesive film glued on to the periphery of the bipolar collector. U.S. Pat. No. 7,320,846 may also be mentioned, which describes a solution involving encasing collectors and electrolytes in a resin. U.S. Pat. No. 7,163,765 may also be mentioned, which describes a sealing solution with mixed struts made of polyamide/PP, arranged between bipolar collectors, where the polyamide is cemented directly on to the periphery of the collectors at a certain distance from the cells). U.S. Pat. No. 7,097,937, for its part, proposes a double sealing solution, since an internal barrier made of a fluoropolymer is fitted on to the periphery of the bipolar collector and an external frame made of elastomer is fitted outside the barrier on and around the bipolar collector with, possibly, an additional ring made of elastomer fitted on the collector. Lastly, patent application EP 2073300, in the applicant's name, may be mentioned, which proposes a solution where the dimensions of the plates are increased relative to the one adjacent to them, and the sealing devices interposed between the interconnecting plates are offset transversely in order that two seals are not located in line with one another in the stacking axis of the cells.

The previously envisaged solutions to improve the mutual sealing of compartments against the liquid electrolyte in a Li-ion bipolar battery may thus be summarised as follows:
systematic production of the bipolar electrode in the form of a plate coated either side by materials of different polarities;
use of various bonds or resins on the periphery of the plate for a seal between compartments, which can be made greater by the overall seal of the battery called the casing;
increase of the bipolar current collector plate format to create an additional barrier against the electrolyte.

In certain bipolar batteries the widely used liquid electrolyte and separator can be replaced by an ionic conductor (conductive gel or polymer), called an “all-solid” conductor. The seal between compartments can then be eliminated, and only the overall seal (casing) of the bipolar element remains.

The term “bipolar element” is used below, and in the context of the invention, to designate the stack formed by the assembly of bipolar electrodes, electrochemical cells with their monopolar electrodes either side of the stack, and producing a bipolar battery architecture.

Depending on the type of application sought, the aim is to manufacture either a flexible bipolar lithium-ion element, or a rigid bipolar element: the casing is then either flexible, or rigid, and in some way constitutes a case.

Flexible casings are currently manufactured from a multi-layered material typically consisting of a stack of aluminium layers covered by a polymer. In most cases, the polymer covering the aluminium is chosen from among polyethylene (PE), propylene or polyamide (PA), or may be in the form of an adhesive layer consisting of polyester-polyurethane. The company Showa Denko sells this type of composite material for use as a casing for batteries. This type of flexible casing manufactured from a stack of aluminium layers supplied by the company Showa Denko is sold, for example, with the references N° ADR-ON25/AL40/CPP40 or N° ADR-ON25/AL40/CPP80. The flexible casings can also be constituted by a resin which encases the element either on its periphery, or over its entire external surface, to improve the seal of the compartments between one another, as described in patent application JP 2000030746. But in this case neither type of flexible casing cited allows pressure to be applied to the bipolar element. And application of pressure at the surface, either side of the bipolar element, is inevitable for its satisfactory operation, more specifically when it includes more than two electrochemical compartments.

Rigid casings are satisfactory from the standpoint, since they enable a sufficient pressure to be maintained either side of the surface of the bipolar element, in order to ensure satisfactory contact between the electrodes and the separator in each of the compartments. It may be mentioned that the sole function of such rigid casings is then, ultimately, only to apply pressure to the bipolar element, since beforehand each of the compartments is previously sealed against air and against the liquid electrolyte using the solutions mentioned above. An example of such rigid casings is described in U.S. Pat. No. 5,595,839: the solution consists in placing the bipolar element in a case formed from two half-shells screwed together so as to maintain optimum contact between each of the active portions of the bipolar element. This case is an experimental case which cannot be used as an industrial case since it is heavy, implying a low resultant specific energy for the battery. Another example is given in patent U.S. Pat. No. 5,618,641, in which the system for applying pressure to the Li-ion bipolar element constitutes a heavy rigid casing fitted with springs.

The rigid casings currently used can therefore be heavy, and the resultant Li-ion battery also has a low specific energy.

The aim of the invention is, then, to propose a novel casing for a bipolar electrochemical battery, such as a Li-ion bipolar battery, in order to constitute a bipolar battery which does not have the disadvantages of the casings of the prior art.

### ACCOUNT OF THE INVENTION

To accomplish this, the object of the invention is a bipolar lithium electrochemical battery including at least one bipolar element, and a casing encapsulating the bipolar element, characterised in that the casing consists of a composite material, including a matrix and at least one porous reinforcement, the matrix of which includes at least one hardened polymer impregnating the porous reinforcement(s), where the porous reinforcement(s) and the hardened polymer(s) encase the bipolar element and apply a determined pressure either side of the latter, so as to maintain a determined contact between its constituents.

Thus, according to the invention, a bifunctional casing is defined, including at least two portions, namely:
at least one porous reinforcement which is required to maintain optimum contact between the components of the Li-ion bipolar element, and which, when the polymer(s) is/are subjected to pressure, prevents it/them from creeping towards the exterior, and therefore does not implement the function of maintaining pressure of the constituents of the bipolar element,
at least one hardened polymer impregnating the porous reinforcement, such as a monocomponent or bicomponent resin, whether or not filled with reinforcing elements, and which provides a seal.

While the matrix (hardened polymer(s)) and the porous reinforcement(s) completely encase the Li-ion bipolar element, pressure will be exerted on its surfaces on either side. The polymer(s) then penetrate(s) the cracks of the reinforcement. When the resin has hardened the pressure exerted on the Li-ion bipolar element, which is typically obtained by a press, is maintained by the formed composite and the encased bipolar element can be removed from the press.

The Li-ion bipolar architecture enables another type of casing to be envisaged. Indeed, the liquid electrolyte is already trapped in each of the compartments of the bipolar element, and isolated from the exterior (the compartments are sealed against gas and against the electrolyte). The function of the casing for a bipolar element is then merely to maintain pressure for optimum contact between the components (electrodes, separators) of the Li-ion bipolar element. If, however, the seal must be reinforced, a double sleeve (resin) may be added over the entire external surface of the bipolar element.

A reinforcement according to the invention can be a fabric such as a taffeta, serge, satin, etc., or another type with a different weave. It can also be non-woven (mat). The reinforcement according to the invention can consist of long fibres or short fibres.

The reinforcement material according to the invention can consist of metal oxides and hydrates or organic fillers (cellulosic fillers used as fillers of thermosetting resins), mineral fillers (carbonate chalks, silicas, talcs (which contribute thermal insulation and water resistance), wollastonite (used mainly with polyamides), clays and aluminosilicates.

A reinforcement according to the invention may contain glass fibres (cut fibres, powder, hollow balls, microspheres), carbon fibres (carbon black, carbon nanotubes, cut carbon fibres), cellulose fibres, silica (or quartz) fibres, aramid fibres, boron fibres, high-modulus polyethylene, or natural fibres (corn, banana tree, coconut palm, etc.).

A reinforcement according to the invention can belong to each of the families above, or consist of a blend of the above families.

A reinforcement according to the invention is preferably a fibre-based material, or one constituted by a fabric, which enables the thickness of the composite, i.e. the total thickness of the matrix and of the reinforcement, to be set easily.

A reinforcement according to the invention may be non-conductive (among the list given above) and encase the bipolar element entirely.

A reinforcement according to the invention may also be non-conductive (among the list given above) but covered with a metal enamel coating.

A reinforcement according to the invention is advantageously at least partly conductive. Care is then taken that the upper and lower faces of the bipolar element are covered only partially, to prevent any electrical short-circuit between the two faces. A non-conductive peripheral frame, constituted for example by a non-conductive fabric impregnated with a resin, is then positioned on the periphery of the bipolar element.

A reinforcement according to the invention can be a current collector grid (Al or Cu) of relatively fine mesh (preferably <1 mm), in order that the surface of the bipolar element is not subject to “wave” phenomena due to the mesh.

As impregnation polymer(s) which are suitable in the context of the invention, the following may be envisaged:
thermohardening resins (saturated or unsaturated polyesters, vinyl esters, epoxy, polyurethanes and polyureas, polyimides, bismaleimides, etc.); a reinforcement with long fibres may then be envisaged due to the thermal, chemical and dimensional stability provided by the cross-linking;
thermoplastic matrices, including polyamide, polycarbonate, polyamide-imide, polyether-imide matrices; in the case of thermoplastic matrices used in addition to long fibres, whether or not woven, an additional reinforcement using short fibres may then be envisaged for improved thermal and mechanical properties, and satisfactory dimensional stability.

Epoxy, polyurethane, polyimide, acrylic or styrenic resins with a high vitreous transition temperature T_{g}, and which are therefore rigid at ambient temperature, may preferentially be used. These resins have the advantage that they resist any leakages of electrolyte which might occur in the bipolar element which they enclose.

Monocomponent or bicomponent resins, or resins which can be photopolymerised under UV radiation, can also advantageously be used, in order that their hardening occurs at ambient temperature, and that there is thus no requirement to apply heat.

Unfilled or filled resins may be used. The resins are preferably non-conductive, although conductive resins may be used to cover only the active surface (or a portion of the active surface) of the element.

The porous reinforcement(s) preferably consist of at least two portions, one of which on each face of the bipolar element.

According to a variant, the poles forming the battery's charging terminals are constituted by tabs which extend towards the outside from within the battery, projecting from the hardened polymer(s).

According to another variant, the poles forming the battery's charging terminals are constituted by at least two contacts, one of which is fitted on one face of the battery, and the other of which, of opposite polarity, is fitted on the other face of the battery. According to this variant, the poles are constituted by at least four contacts, where each face of the battery includes at least two poles, one negative and one positive, with a pole in each corner, and both poles of one face are facing each of the two poles of the other face, and where two poles of a given corner are of the same polarity.

A preferred embodiment consists of a composite material with the porous reinforcement(s) made of carbon fibre, and an epoxy resin as the hardened polymer.

Another object of the invention is a method for producing a casing of a lithium bipolar electrochemical battery including a bipolar element, according to which the following steps are accomplished:

a/ installation of a subassembly including a bipolar element between two portions of at least one porous reinforcement impregnated by at least one polymer or one or more monomers in a mould,

b/ application of a determined pressure either side of the two impregnated reinforcement portions of the subassembly in the mould, until the polymer(s) is/are hardened.

For step a/, impregnation of both porous reinforcement portions may be envisaged after these portions have been installed exposed around the bipolar element.

Alternatively, porous reinforcement portions pre-impregnated by at least one polymer or one or more monomers (also designated by the term “prepreg”) may be envisaged.

To accomplish step b/ of the method according to the invention, a press is used to apply the necessary pressure for optimum contact between the components of the bipolar element. Internal resistance measurements made on bipolar elements with a different number of compartments have revealed that the pressure to be exerted depends on the number of stacked compartments. For example, in the case of a bipolar element with a 700 mAh capacity, including a number between 1 and 13 of stacked compartments, it transpires that the pressure to be exerted varies from 0.05 MPa to 0.5 MPa.

Step b/ is preferably accomplished at ambient temperature.

A reinforcement according to the invention is preferably able to maintain sufficient porosity, typically of approximately 40%, when subject to a pressure which may be as high as 0.5 MPa, to enable satisfactory impregnation of the reinforcement by the resin during the application of the pressure.

Lastly, the invention concerns an assembly, commonly designated by the term “battery pack”, made from multiple bipolar batteries according to the invention.

An assembly may consist in connecting in electrical series batteries with flat contact terminals, by a stack of batteries defined above, in which the contacts of reverse polarity between two adjacent batteries are in contact.

Another assembly may consist in connecting in electrical parallel batteries with flat contact terminals, by a row of batteries defined above, in which the contacts of the same polarity are connected to one another by an electrical connecting strip.

Another assembly may consist in connecting in electrical parallel batteries with flat contact terminals, by a stack of batteries defined above, in which the contacts of the same polarity between two adjacent batteries are in contact.

Advantageously, all the batteries of a given assembly have the same unit power, typically of the order of 15 Wh.

### BRIEF DESCRIPTION OF THE ILLUSTRATIONS

Other advantages and characteristics of the invention can be deduced on reading the detailed description given as an illustration, and not restrictively, with reference to the following figures which represent respectively:

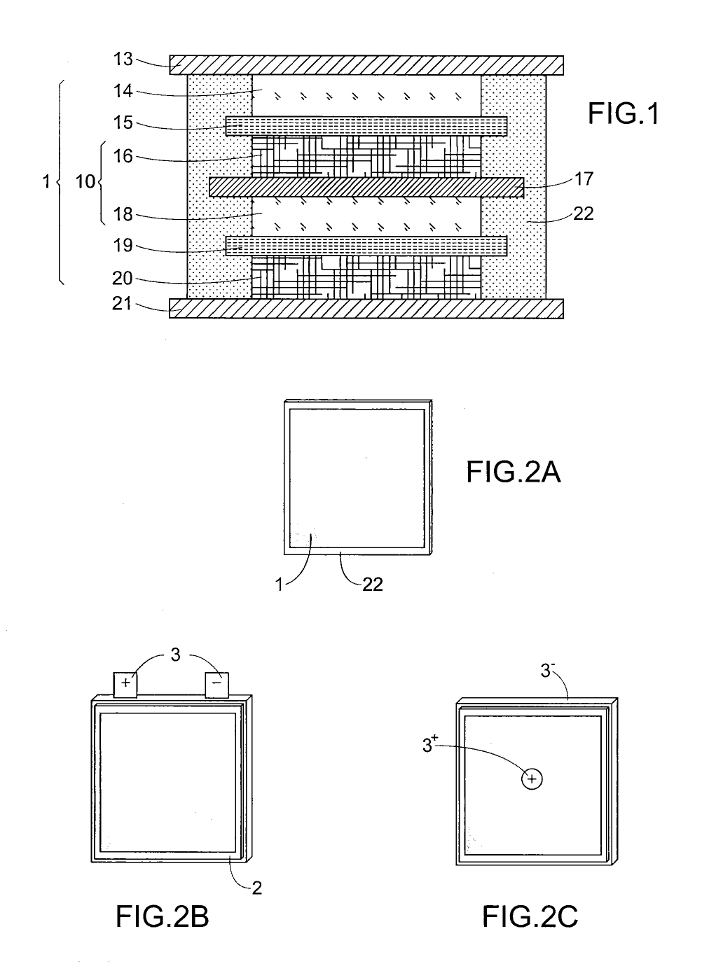

FIG. 1 is a schematic, lengthways section view of a lithium bipolar battery according to the state of the art without its casing,

FIG. 2A is a front view showing a bipolar element according to the invention without its casing,

FIG. 2B is a front view showing a lithium-ion bipolar battery including a bipolar element with its flexible casing according to the state of the art,

FIG. 2C is a front view showing a lithium-ion bipolar battery including a bipolar element with its rigid casing according to the state of the art,

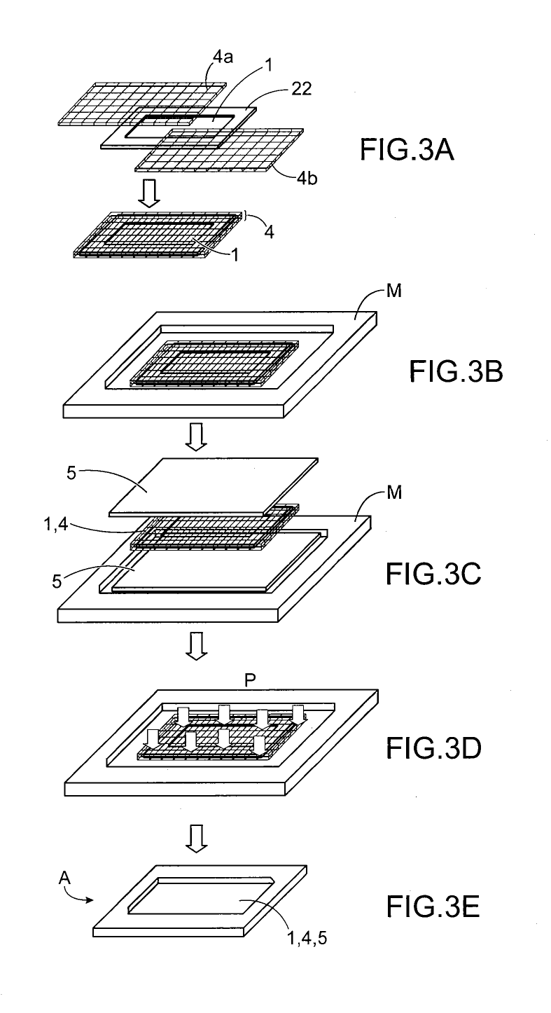

FIGS. 3A to 3D are perspective schematic exploded views showing the different steps of manufacture of a lithium-ion bipolar battery with its casing according to the invention,

FIG. 3E is a perspective view of a lithium-ion bipolar battery with its casing according to the invention, obtained according to the method of steps 3A to 3D;

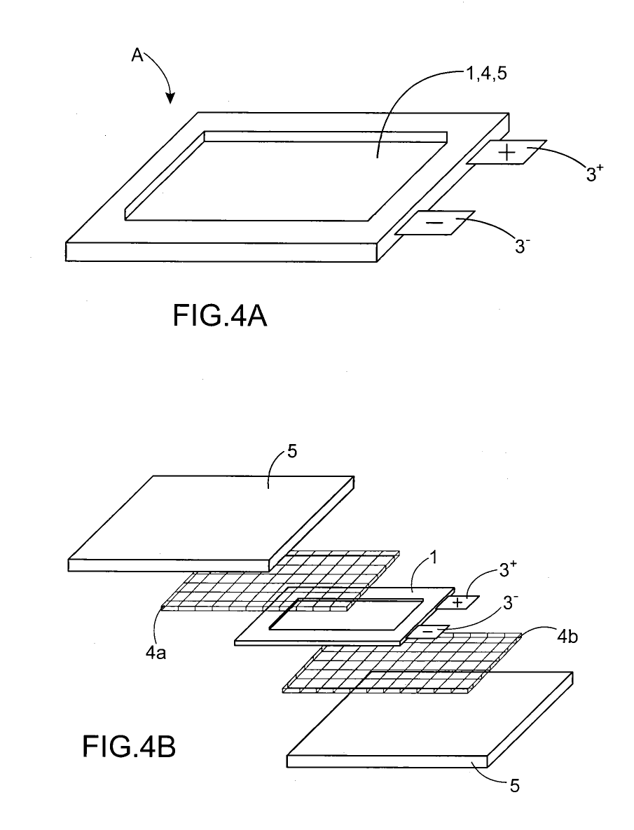

FIGS. 4A and 4B are respectively a finished perspective view and an exploded perspective view of a lithium-ion bipolar battery with its casing and its poles according to a variant of the invention;

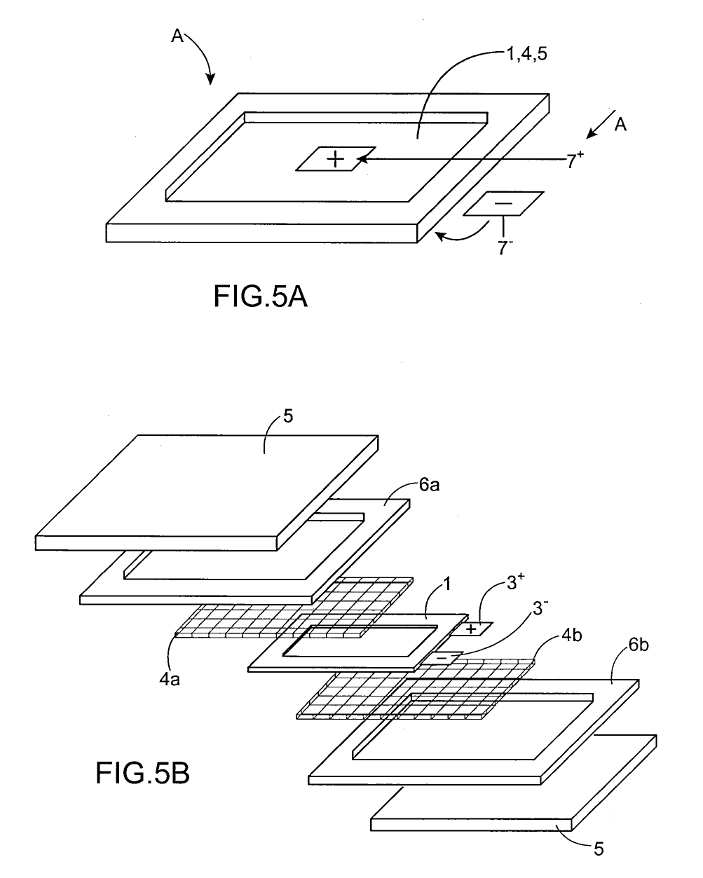

FIGS. 5A and 5B are respectively a finished perspective view and an exploded perspective view of a lithium-ion bipolar battery with its casing and its poles according to another variant of the invention;

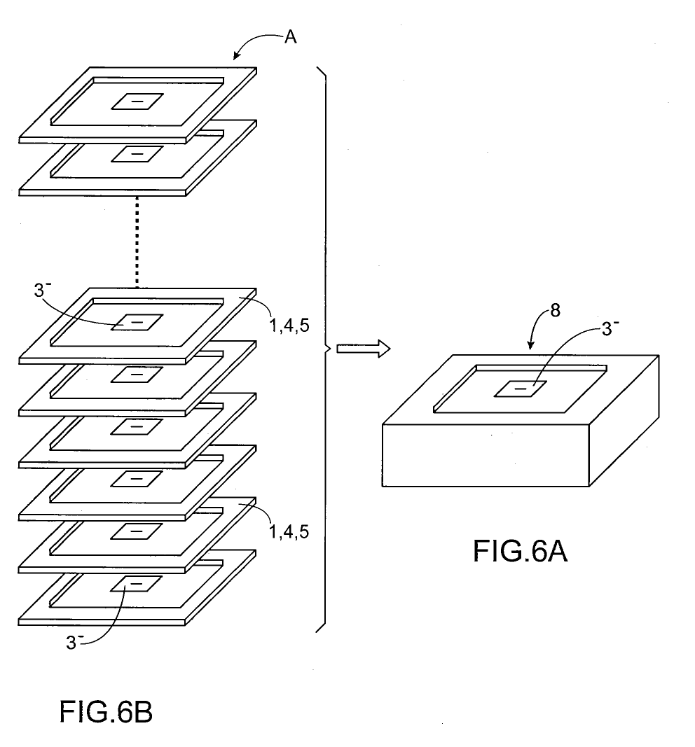

FIGS. 6A and 6B are respectively a finished perspective view and an exploded perspective view of a series assembly of multiple batteries according to FIGS. 5A and 5B;

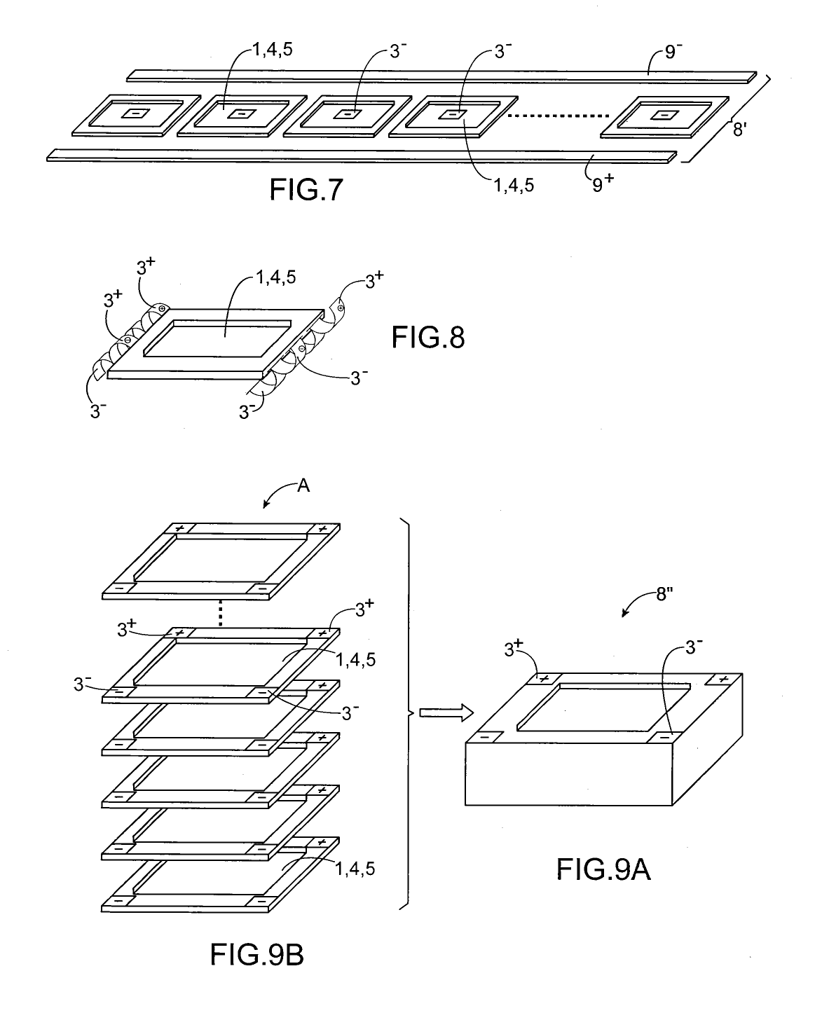

FIG. 7 is an exploded perspective view of a parallel assembly of multiple batteries according to FIGS. 5A and 5B;

FIG. 8 is a finished perspective view of a lithium-ion bipolar battery with its casing and its poles according to a variant of the invention;

FIGS. 9A and 9B are respectively a finished perspective view and an exploded perspective view of a parallel assembly of multiple batteries according to FIG. 8.

### DETAILED ACCOUNT OF PARTICULAR EMBODIMENTS

For clarification, the terms “conductive” and “non-conductive” are used in reference to electrical conductivity.

A Li-ion bipolar battery according to the state of the art has been represented in FIG. 1, as it is illustrated in patent application WO 03/047021, without its casing.

This battery includes in its upper portion a conductive aluminium substrate 13 (positive terminal current collector) and an active layer 14 made of a positive lithium insertion material, such as Li_{1.04}Mn_{1.96}O₄, and in its lower portion a conductive aluminium substrate 21 (negative terminal current collector) and an active layer 20 made of a negative lithium insertion material, such as Li₄Ti₅O₁₂.

Within this battery, a bipolar element 1 with a bipolar electrode 10, also called a bipolar current collector, includes a positive active layer 18 and a negative active layer 16, either side of a conductive aluminium substrate 17 in the form of a plate.

Lower 20 and upper 14 electrodes are separated from bipolar electrode 1 by two separators 15, 19, in which an electrolyte is present in a liquid or gel form. Sealing against the electrolytes of the battery between the two constituted adjacent electrochemical cells 14, 15, 16 and 18, 19, 20 is provided by a seal 22 which is produced by deposition of resin or adhesive on the periphery of all the electrodes and plate 17.

A bipolar element 1 with at least two compartments which it is sought to encase according to the invention therefore consists of elements 14, 15, 16, 17, 18, 19, 20 with its seal 22 as better represented in FIG. 2A.

A Lithium ion battery with its flexible casing 2 according to the state of the art is represented in FIG. 2B. Poles 3+, 3− are here constituted by strips which extend in a transverse plane outside casing 2.

A Lithium ion battery with its rigid casing 2 according to the state of the art is represented in FIG. 2C. Poles 3+, 3− are here constituted by metal contacts on the front and back faces of casing 2.

When they have been sealed or welded, the casings of the flexible or rigid Li-ion bipolar batteries according to the state of the art allow firstly the liquid electrolyte to be partitioned, and all gaseous exchanges with the ambient air to be prevented, and secondly optimum contact between the components of the bipolar element to be achieved (FIG. 2C).

However, rigid casings can be heavy.

In FIG. 3E a bipolar battery according to the invention has been represented, with a bipolar element 1 supplying a voltage of 24V, and consisting of a number of thirteen unit compartments, the cathode and anode materials being respectively LiFePO₄/Li₄Ti₅O₁₂. Bipolar element 1 is encapsulated in a rigid casing consisting of a composite material including an epoxy resin 5 and a carbon fibre fabric 4.

To produce this battery 1 with a rigid casing, the following steps are implemented:

Step 1:

The thickness of bipolar element 1 alone is 3 mm. The thickness of each portion 4a, 4b of carbon fibre fabric 4 used is of the order of 1 mm, and typically less than 5 mm.

Two portions 4a, 4b of two-way carbon fibre fabric 4 are positioned over the entire surface of bipolar element 1, which has been previously sealed within a resin 22 on its periphery: both portions 4a, 4b of porous reinforcement 4 thus extend beyond the surface of polar element 1 over a peripheral width at least equal to 2 mm (FIG. 3A).

Step 2:

A mould M, the dimensions of which are chosen such that they are of the order of the final dimensions of the assembly which it is desired to obtain, is positioned on the plates of a press (FIG. 3B).

Bipolar element 1, which is covered with carbon fibre fabric 4, is then placed in the mould (FIG. 3C).

In the base of the mould a resin 5 is deposited. The same resin 5 is deposited on the top (portion 4a) of fabric 4. Resin 5 is preferably an epoxy resin.

The bipolar element may also be wrapped in a single fabric 4 of prepreg resin fibres, the effect of which is that there is then no requirement to deposit resin in the mould above a portion 4a of exposed fabric.

Step 3:

A pressure of the order of 0.5 MPa is applied to the subassembly. The pressure will be maintained until resin 5 has hardened (FIG. 3D).

Lastly, when resin 5 has hardened, bipolar element 1 with its rigid casing made of composite material 4, 5 in which it is encapsulated, is removed from the press. The Li-ion bipolar battery obtained in this manner 1, 4, 5 has a external thickness of resin equal to the thickness of carbon fibre fabric 4 (FIG. 3E).

The battery according to the invention represented in FIG. 3E has no positive or negative poles, i.e. terminal current collectors.

Different variant embodiments of batteries with their poles are described in detail below.

According to one variant, a battery according to the invention can firstly be produced with poles in the form of two tabs 3+, 3− which extend along the same side from within (FIG. 4A). A bipolar element 1 is firstly produced with tabs 3+, 3− which extend along the same side towards the outside from within the bipolar element. Production of the battery with its casing according to the invention is then accomplished as explained above with reference to steps 1 to 3, with two reinforcement portions 4a, 4b in the form of a frame of non-conductive fabrics or mats and a resin 5 poured on to the latter (FIG. 4B). The length of metal tabs 3+, 3− is naturally chosen such that they project from hardened resin 5 at the side of the battery (FIG. 4A).

According to another variant, a battery according to the invention can be produced with poles in the form of two contacts 3+, 3−, each on one of the faces of the casing (FIG. 5A). Production of the battery with its casing is then accomplished as explained above with reference to steps 1 to 3, with two reinforcement portions 4a, 4b in the form of a frame of conductive fabrics or mats, two additional reinforcement portions 6a, 6b in the form of a frame of non-conductive fabrics or mats, and a resin 5 poured on to these fabrics or mats (FIG. 5B). Conductive reinforcing frames 4a, 4b have roughly the surface dimensions of the functional portion of bipolar element 1, i.e. without its portion performing seal 22 at its periphery. Additional reinforcing frames 6a, 6b, which are non-conductive, are for their part fitted to the periphery of frames 4a, 4b. Portions of metal sheets 7+, 7− which are rigidly connected to conductive reinforcing frames 4a, 4b thus form contacts 3+, 3−. It may be envisaged to connect these portions of metal sheets rigidly to frames 4a, 4b before pouring resin 5, or afterwards, when it has hardened. In this latter case, care is taken to leave portions of frames 4a, 4b clear when resin 5 is poured.

As represented in FIG. 6A, an assembly 8 of electrical high voltage, commonly designated by the term “battery pack”, can be produced without any additional electrical connection, by connecting several batteries in series according to FIG. 5A. To accomplish this, the multiple batteries according to FIG. 5A are stacked, bringing into contact contacts 3+, 3− of reverse polarity between two adjacent batteries, as represented in FIG. 6B. To clarify, since this FIG. 6B is an exploded perspective view, only contacts 3− of the same polarity for all the batteries can be seen. Thus, by stacking ten batteries with identical bipolar elements of unit power equal to 15 Wh, an assembly or battery pack 8 can be obtained which is able to supply a voltage of 240 V.

As represented in FIG. 7, a high-energy assembly or battery pack 8′ can be produced, with a minimum of additional electrical connections, by placing in parallel several batteries according to FIG. 5A. To accomplish this, the multiple batteries are placed side-by-side according to FIG. 5A, bringing into contact the positive contacts, firstly, and the negative contacts, secondly, between two adjacent batteries. The number of electrical connections is minimal, since only two connecting strips 9+, 9− are added either side of the row of batteries, where these connecting strips 9+, 9− thus form terminal current collectors of pack 8. Thus, by forming a row of ten batteries with identical bipolar elements of unit power equal to 15 Wh, an assembly or battery pack 8 can be obtained with a total power of 150 Wh. The inventors thus believe that such an assembly 8 according to FIG. 7 is perfectly suitable to be installed in a motor vehicle called a micro-hybrid.

In FIG. 8, a battery has been represented with four poles, two of which negative, 3−, and two of which positive, 3+, and all of which are in the form of metal tabs connected to bipolar element 1, and are folded back on the faces of a battery. More accurately, each tab 3 is folded back on to one of the faces of the battery at a corner. In a given corner, two tabs of the same polarity are folded back respectively each on one face. In other words, each face of a battery includes four poles, two of them negative, 3−, and two of them positive, 3+, with a pole in each corner, and the four poles of one face are opposite each of the four poles of the other face, where two poles of a given corner are of the same polarity.

As represented in FIG. 9A, a high-energy assembly or battery pack 8″ can be produced, without any additional electrical connection, by placing in parallel several batteries according to FIG. 8. To accomplish this, the multiple batteries according to FIG. 8 are stacked, bringing into contact all contacts 3+, 3− of reverse polarity between two adjacent batteries, as represented in FIG. 9B. Thus, by forming a stack of ten batteries with identical bipolar elements of unit power equal to 15 Wh, an assembly or battery pack 8 can be obtained with a total power of 150 Wh. Assembly 8″ according to FIG. 9B is thus an alternative to assembly 8′ according to FIG. 7, to constitute a battery pack of 150 Wh. A major advantage of the assembly of FIGS. 9A and 9B compared to that of FIG. 7 is its compactness. It should be noted that it is possible to have as few as two contacts for each face, but by fitting one in each of the corners of the bipolar cells, as represented in FIG. 9B, the conductivity of the resulting assembly or electrical pack can be improved.

1-16. (canceled)

17. A bipolar lithium electrochemical battery comprising:
at least one bipolar element; and
a casing encapsulating the bipolar element;
wherein the casing includes a composite material, including a matrix and at least one porous reinforcement, the matrix of which including at least one hardened polymer impregnating the at least one porous reinforcement, wherein the at least one porous reinforcement and the at least one hardened polymer encase the bipolar element and apply a determined pressure to either side of the bipolar element, to maintain a determined contact between its constituents.

18. The lithium bipolar electrochemical battery according to claim 17, wherein the at least one porous reinforcement is fabric and/or a mat.

19. The lithium bipolar electrochemical battery according to claim 17, wherein the at least one porous reinforcement includes at least two portions, one on each face of the bipolar element.

20. The lithium bipolar electrochemical battery according to claim 17, wherein poles forming charging terminals of the battery include tabs that extend towards outside the battery from within the battery, projecting from the at least one hardened polymer.

21. The lithium bipolar electrochemical battery according to claim 17, wherein poles forming charging terminals of the battery include at least first and second contacts, the first contact fitted on to one face of the battery, and the second contact is of opposite polarity and fitted on to another face of the battery.

22. The lithium bipolar electrochemical battery according to claim 21, wherein the poles include at least four contacts, wherein each face of the battery includes at least two poles, one negative and one positive, with a pole in each corner, and both poles of one face face each of the two poles of the other face, and wherein two poles of a given corner are of same polarity.

23. The lithium bipolar electrochemical battery according to claim 17, wherein the at least one porous reinforcement is made from carbon fibers and the hardened polymer is an epoxy resin.

24. A method for producing a casing of a lithium bipolar electrochemical battery including a bipolar element, the method comprising:
installing a subassembly including a bipolar element between two portions of at least one porous reinforcement impregnated by at least one polymer or one or more monomers in a mold;
applying a determined pressure to either side of the two impregnated reinforcement portions of the subassembly in the mold, until the at least one polymer is hardened.

25. The method according to claim 24, wherein the method includes impregnation of both porous reinforcing portions after they are installed exposed around the bipolar element.

26. The method according to claim 24, wherein the installing includes installing porous reinforcing portions that have been pre-impregnated by at least one polymer or one or more monomers.

27. The method according to claim 24, wherein the applying is accomplished at ambient temperature.

28. The method according to claim 24, wherein the applying is accomplished with a pressure between 0.05 MPa and 0.5 MPa.

29. An assembly including a stack of batteries according to claim 21, wherein contacts of opposite polarity between two adjacent batteries are in contact.

30. An assembly including a row of batteries according to claim 21, wherein contacts of a same polarity are connected to one another by an electrical connecting strip.

31. An assembly including a stack of batteries according to claim 22, wherein the contacts of a same polarity between two adjacent batteries are in contact.

32. An assembly according to claim 31, wherein all batteries have a same unit power.
